(19) United States
(12) Patent Application Publication
(10) Pub. No.: US 2022/0105483 A1
(43) Pub. Date: Apr. 7, 2022

(54) METHOD AND DEVICE FOR CONTROLLING THE TEMPERATURE OF REACTION MIXTURES IN AN AGITATION OPERATION

(71) Applicant: AQUILA BIOLABS GMBH, Baesweiler (DE)

(72) Inventors: Konrad Herzog, Herzogenrath (DE); David Frank, Herzogenrath (DE)

(21) Appl. No.: 17/427,051

(22) PCT Filed: Jan. 21, 2020
(86) PCT No.: PCT/EP2020/051371

§ 371 Date: Jul. 29, 2021

(30) Foreign Application Priority Data
Jan. 30, 2019 (DE) 10 2019 000 673.9

(51) Int. Cl. B01F 35/92; B01F 31/22; B01L 7/00

(52) U.S. Cl. CPC B01F 35/92; B01F 2035/99; B01L 7/00; B01F 31/22

(57) ABSTRACT

The invention relates to a method for controlling the temperature of reaction mixtures (2) in an agitation operation, wherein at least two reaction mixtures (2) in at least two reaction vessels (1) are individually temperature-controlled, said reaction mixtures (2) in said reaction vessels (1) being subjected to a common agitation movement (3), the individual temperature control of at least two reaction mixtures (2) being carried out by means of a separate heat transfer (6) between each at least one reaction mixture (2) and at least one temperature control zone (4) associated with said reaction mixture (2).

### CROSS REFERENCE TO RELATED APPLICATIONS

This is a US national phase application under 35 U.S.C. § 371 of international application no. PCT/EP2020/051371, filed 21 Jan. 2020, which claims benefit of priority to German patent application no. 102019000673.9, filed 30 Jan. 2019; the entire content of each is herein incorporated by reference in its entirety

### TECHNICAL FIELD

The invention relates to a methods and devices for controlling the temperature of reaction mixtures in an agitation operation and more specifically to the individual temperature control of two reaction mixtures by means of a separate heat transfer between at least one reaction mixture and a temperature control zone associated with the reaction mixture during the cultivation of cells or the execution of chemical reactions.

### BACKGROUND OF THE INVENTION

Temperature is an essential process parameter of every biological, chemical or physical process. Such processes take place in reaction mixtures and are carried out in reaction vessels which are frequently agitated for the purpose of mixing the reaction mixture in the reaction vessel.

Setting and maintaining a certain temperature in the reaction mixture is critical for the success of any reaction process since the temperature influences, for example, the speed or equilibrium of reactions, mass transport processes or cultivation processes. Every cell or cell line has an optimal cultivation temperature, for example. The yield and quality of the expression of proteins can be regulated via the temperature, for example, by reducing the temperature to allow for a slower translation and thus a better protein folding. Chemical reactions or biochemical assays can also be regulated with regard to their yield, stereo symmetry, purity, specificity, etc., by setting a suitable temperature.

### PRIOR ART

In order to achieve a high experimental throughput, especially in development and screening processes, agitation processes are often carried out in parallel in or on agitation machines with several reaction vessels filled with reaction mixtures being fastened together on an agitation platform and being agitated by said machine.

A person skilled in the art is familiar with agitation machines in which the agitation platform is located in an incubator. To control the temperature of the reaction mixtures in an agitation operation, the gas phase in the incubator, which also surrounds the reaction vessels, is temperature-controlled so that, in the equilibrium state, all reaction vessels and the reaction mixtures contained in them have the temperature of the gas phase in the incubator. Embodiments for this are typical incubation agitators for shaking flasks, reaction tubes or microtiter plates. The temperature of the reaction mixtures is controlled by means of heat conducted between the incubator gas phase and the reaction mixture via the respective reaction vessel.

Furthermore, agitation machines whose temperature control method comprises a temperature control liquid and which are often designed as shaking water baths are known. In this method, the equilibrium temperature of all reaction vessels and reaction mixtures on an agitation platform corresponds to the temperature of the temperature control liquid. The temperature of the reaction mixtures is likewise controlled by means of heat conduction between the incubator temperature control liquid and the reaction mixture via the respective reaction vessel.

A disadvantage with regard to the above-described temperature control method for reaction mixtures in an agitation operation is the method-related setting of the same temperature in all reaction mixtures that are agitated together. This is particularly disadvantageous because the available agitation capacity can only be fully and optimally utilized if all processes running in parallel have the same optimal temperature requirements at all times. In the case of development and screening processes, in particular, however, this is mostly not the case.

This also has the disadvantage that the temperature of a certain reaction mixture cannot be adjusted individually on the basis of the respective progress of the process taking place in said mixture without negatively influencing the processes of the other agitated reaction mixtures.

This is disadvantageous, in particular, in consideration of the increasingly available process-characterizing online sensor systems, which only allow a fundamentally advantageously individualized process management that is tailored to the recorded measurement data.

EP 1 393 797 A2 discloses a device of the type mentioned in which several reaction mixtures are held in vessels. The vessels are separated from one another by at least air. The reaction mixtures are all temperature-controlled by a single, common heating device (para. [0037]).

### OBJECT OF THE INVENTION

It is therefore the object of the present invention to provide a method by means of which the temperature of jointly agitated reaction mixtures can be controlled individually, so negative influences on processes in other simultaneously agitated reaction mixtures can be avoided in order to set process-specific, optimal temperature conditions for each reaction mixture.

### BRIEF SUMMARY OF THE INVENTION

According to the invention, the object is achieved by a method for controlling the temperature of reaction mixtures in an agitation operation, wherein at least two reaction mixtures in at least two reaction vessels are individually temperature-controlled and are subjected to a common agitation movement, the individual temperature control of the at least two reaction mixtures being carried out by means of a separate heat transfer between the at least one reaction mixture and at least one temperature control zone associated with this reaction mixture.

By using reaction mixture-specific temperature control zones, the method, according to the invention, thus advantageously allows for an individual process control at optimal temperature conditions in each reaction mixture with the heat transfer to each individual reaction mixture taking place and being regulated separately.

In an advantageous embodiment of the invention, at least two reaction mixtures, each in their reaction vessels, are separated from one another by at least one isolation zone so that the maximum achievable heat transfer between at least two reaction mixtures is smaller than the maximum achievable heat transfer between at least one temperature control zone and a reaction mixture associated with it.

In some embodiments of the invention, each reaction vessel with the reaction mixture is surrounded by an isolation zone throughout, apart from the interaction region with at least one temperature control zone.

In an advantageous embodiment of the invention, at least two temperature control zones are separated from one another by at least one isolation zone so that the maximum heat transfer that can be achieved between the at least two temperature control zones is less than the maximum heat transfer that can be achieved between each of the temperature control zones and at least one of their respective associated reaction mixtures.

In an advantageous embodiment of the invention, at least one temperature control zone is associated with each reaction mixture in a reaction vessel. In some embodiments of the invention, a plurality of reaction mixtures are temperature-controlled by means of at least one common temperature control zone.

In an advantageous embodiment of the invention, the temperature control of at least one reaction mixture takes place over a plurality but at least two temperature control zones.

In an advantageous embodiment of the invention, the interaction surfaces between the temperature control zones and the temperature-controlled reaction mixture are significantly smaller than the total surface of the reaction mixture, in particular >2 times smaller, >5 times smaller or >10 times smaller. In some embodiments of the invention, this allows for an in-process adaptation of the overall temperature control zone as an array of small temperature control zones to the shape and size of the reaction mixture or the associated reaction vessel to be temperature-controlled.

In some embodiments of the invention, there is at least one temperature control zone that runs along or is in the vicinity of the contact surface between at least one temperature control element and at least one reaction vessel containing the reaction mixture to be temperature-controlled. Temperature control elements, according to the invention, with a contact surface are, in particular but not exclusively, electrical heating plates and foils, Peltier elements, heat pumps, heat exchangers or refrigerating machines. In an advantageous embodiment of the invention, temperature control elements with a contact surface to at least one reaction vessel have high thermal conductivities and thus allow for a high maximum heat transfer compared to isolation zones.

In some embodiments of the invention, there is at least one temperature control zone that also runs along or is in the vicinity of the contact surface between a fluid flow caused by at least one temperature control element and a reaction mixture or a reaction vessel which contains the reaction mixture to be temperature-controlled. According to the invention, such fluid flows are, in particular but not exclusively, air or other gas flows and flows of liquid coolants or heat conductors. Temperature control elements, according to the invention are therefore also all blowers, turbines or pumps that are operated in combination with devices that allow for a temperature control of the fluid flow.

In some embodiments of the invention, there is at least one temperature control zone that also runs along or is in the vicinity of the thermal radiation interaction surface or the interaction volume (in particular, infrared radiation) with at least one reaction mixture or at least one reaction vessel containing the reaction mixture to be temperature-controlled.

Temperature control elements, according to the invention, are therefore also all emitters of thermal radiation, in particular but not exclusively heat lamps, infrared LEDs, heating rods and coils or other heat radiators.

According to the invention, different temperature control elements can be combined for controlling the temperature of at least one reaction mixture (for example, cooling using Peltier elements or heating using infrared radiators).

According to the invention, temperature control elements can be integrated into the agitation platform in order to be agitated continuously with the reaction mixtures. In some embodiments of the invention, the temperature control elements are not integrated into the agitation platform, which is particularly advantageous for radiation-based temperature control elements.

According to the invention, temperature control zones can be located either inside or outside the reaction mixture or the reaction vessel, depending on the heat transfer method that is used. In the case of external temperature control zones, the reaction vessel functions as a thermal bridge for the transfer of heat between the temperature control zone and the reaction mixture. According to the invention, the heat transfer between the temperature control zone and the reaction mixture can take place both unidirectionally and bidirectionally.

In some embodiments of the invention, at least one reaction mixture is cooled or heated by means of the same at least one temperature control zone or by means of the same at least one temperature control element. In other embodiments of the invention, temperature control zones or temperature control elements are used which are each suitable either only for cooling or only for heating and can be combined for a full temperature control of the reaction mixture.

In an advantageous embodiment of the invention, only a single reaction mixture is associated with each temperature control zone or each temperature control element

According to the invention, a large temperature control zone can be composed of a plurality of individual smaller temperature control zones. According to the invention, a large temperature control element can also be composed of a plurality of individual smaller temperature control elements. In an advantageous embodiment of the invention, all temperature control zones or temperature control elements can be regulated independently of one another.

In an advantageous embodiment of the invention, the temperature is regulated in the effective region of at least one temperature control zone while measuring the temperature of the respective reaction mixture or reaction vessel. According to the invention, the temperature of the temperature control zone or of the temperature control element itself or of the space between at least two temperature control zones or temperature control elements can also be used for regulation purposes.

In an advantageous embodiment of the invention, at least one temperature sensor is associated with each temperature control zone or with each reaction mixture or reaction vessel. Temperature sensors in the context of the invention are all devices that are suitable for generating a signal in order to regulate at least one temperature control zone or at least one temperature control element, in particular but not exclusively electrical temperature sensors (shunt, thermocouple, thermopile, temperature-dependent resistors, etc.), radiation sensors, flow sensors, thermometers, bimetal strips or other stretch strips as well as soft sensors.

According to the invention, the temperature of the reaction mixture, the reaction vessel, the temperature control zones or the temperature control elements are controlled by hardware or software controllers, both according to predetermined setpoints or profiles that are defined in terms of time or events, as well as in feedback to process parameters ascertained during the process (e.g., optical density, fluorescence intensity, exhaust air composition, viscosity, pH, oxygen concentration, etc.), especially those that were recorded in, on or in the vicinity of the reaction mixture to be temperature-controlled.

According to the invention, an isolation zone is characterized by a comparatively low maximum achievable heat transfer so that it can advantageously be used to prevent or limit the heat transfer between at least two reaction mixtures. In the context of the invention, isolation zones are created by thermal insulators, in particular but not exclusively by air, vacuum, hollow chamber structures, plastic or ceramic foams, diffusion, convection and radiation barriers and porous, lightly packed fiber materials. In some embodiments of the invention, the ambient air of the reaction mixtures and the reaction vessels functions as an isolation zone.

In some embodiments of the invention, deactivated or actively counter-regulated temperature control elements or temperature control zones are used as isolation zones.

In some embodiments of the invention, the heat flows in and around each reaction mixture are recorded and balanced in order to obtain information about the processes taking place in the reaction mixture.

The present invention will be explained in more detail with reference to the figures and exemplary embodiments. Reference signs in the figures which designate components of the invention that were used already in the same figure or in another figure under the same circumstances or in the same representation are partially omitted in order to maintain the clarity of the figures. Graphic elements without reference signs are therefore to be interpreted in consideration of the list of reference signs, the other figures, the designated representations within the same figure, the patterning or structuring of already designated graphic elements and with reference to the entire description and the claims.

### BRIEF DESCRIPTION OF THE DRAWINGS

FIG. 1 is a schematic representation of the method, according to the invention, with two reaction vessels 1, which are filled with two reaction mixtures 2 to be individually temperature-controlled and separated by an isolation zone 5.

FIG. 2A and FIG. 2B are schematic representations of an embodiment of the device, according to the invention, for performing the method, according to the invention, for shaking flasks and reaction tubes as reaction vessels 1 on an orbital shaker with individually combined arrays of small temperature control elements 9 and temperature control zones 4.

FIG. 3 is a schematic representation of an embodiment of the device, according to the invention, for performing the method according to the invention for microtiter plates using infrared lighting for the individual temperature control of each well.

### DETAILED DESCRIPTION

### Definitions

To ensure the clarity of some terms used in the description, they are defined and explained below and throughout the description.

Reaction vessels in the context of the invention are all equipment and vessels that are suitable for receiving and storing reaction mixtures. They can be open or closed. Reaction vessels within the meaning of the invention are, in particular but not exclusively, shaking flasks, reaction tubes, falcons, T-flasks, microtiter plates, agitation bags and agitation vessels of any geometry, material composition and filling quantity.

Reaction mixtures within the meaning of the invention are mixtures of at least two components and are, in particular but not exclusively, liquids, solutions, emulsions, dispersions, slurries, suspensions, foams, gas mixtures or powder mixtures. Biological, chemical or physical processes or reactions take place in reaction mixtures. Reaction mixtures within the meaning of the invention, therefore, include, in particular but not exclusively, mixtures of culture mediums and cells, starting materials, catalysts and products, various states of aggregation, etc.

For the purposes of the invention, agitation movements are movements which are suitable for moving or mixing the reaction mixtures contained in them by moving the reaction vessels. Agitation movements within the meaning of the invention are, in particular but not exclusively, orbital agitation, rocking agitation and tumbling agitation. Agitation movements within the meaning of the invention can be carried out continuously or discontinuously, depending on the process requirements.

The temperature control of a reaction mixture in the context of the invention is the setting of a specific temperature in the reaction mixture via the transfer of heat into or out of the reaction mixture. The heat can be transferred directly into or from the reaction mixture or indirectly via the reaction vessel, in particular but not exclusively, via convection, thermal conduction or thermal radiation.

Temperature control zones within the meaning of the invention are all zones, regions, surfaces or volumes that are involved in the targeted heat transfer between the reaction mixture and the temperature control element.

Temperature control elements within the meaning of the invention are all devices that are suitable for generating heat from other forms of energy or for generating temperature gradients, which can be used for controlling the temperature of the reaction mixtures, by heat transport. Temperature control elements within the meaning of the invention are, in particular but not exclusively, electrical heating elements, heating foils, Peltier elements, heat emitters, IR LEDs, heat engines, heat pumps, fans and pumps.

Isolation zones within the meaning of the invention are all zones, regions, surfaces or volumes that limit or prevent the transfer of heat between different reaction mixtures or temperature control zones.

According to the invention, the maximum achievable heat transfer denotes the amount of heat that can be exchanged per time between at least two inventive components, regions, zones, surfaces or volumes under the given conditions (e.g., heating or cooling capacity, temperature difference), regardless of the heat transfer mechanism.

### Described Embodiments

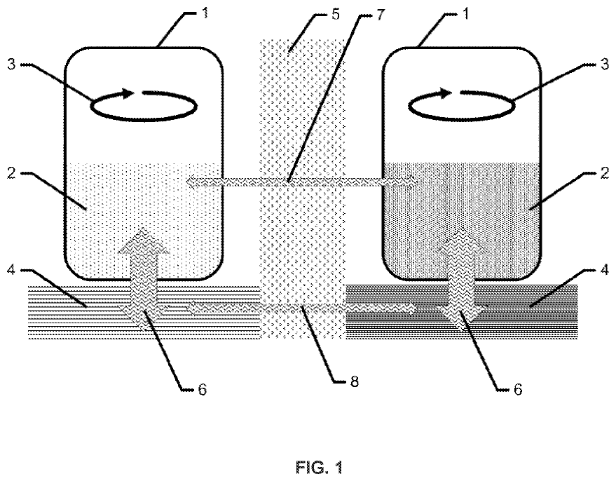

Turning now to the drawings, FIG. 1 shows a schematic representation of the method, according to the invention. Two reaction vessels 1 exposed to the same agitation movement 3 are respectively filled with different reaction mixtures 2 and are individually temperature-controlled by means of the method, according to the invention. To this purpose, each reaction vessel 1 with the reaction mixture 2 contained therein is located in the effective range of a separate temperature control zone 4 that individually carries out the temperature control of the associated reaction mixture 2 by means of a heat transfer 6 between the temperature control zone 4 and the reaction mixture 2.

The reaction mixtures 2 in their reaction vessels 1 are at least partially separated by at least one isolation zone 5 in such a way that the maximum achievable heat transfer 7 between the reaction mixtures 2 is less than the maximum achievable heat transfer 6 between the respective associated temperature control zone 4 and the reaction mixture 2. The temperature control zones 4 are also advantageously separated from one another by at least one isolation zone in such a way that the maximum achievable heat transfer 8 between the temperature control zones 4 is lower than the maximum achievable heat transfer 6 between the temperature control zone 4 and reaction mixture 2 associated with each other. According to the invention, this allows for an individual and process-optimal temperature control of each reaction mixture 2 without a negative influence on the respective individual reaction processes by the temperature or the temperature control of adjacent reaction mixtures 2.

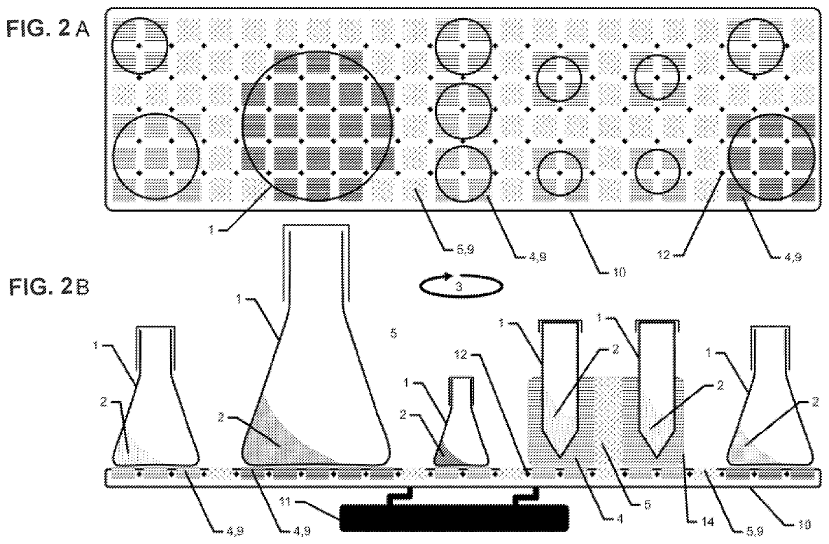

FIGS. 2A-2B show a schematic representation of an embodiment of the device, according to the invention, for performing the method, according to the invention, for shaking flasks and reaction tubes as reaction vessels 1 on an orbital shaker, which comprises at least one agitation drive 11 and one agitation platform 10. FIG. 2A is a top view of the agitation platform 10 whereas FIG. 2B is a side view of the embodiment. FIGS. 2A-2B contain some schematic simplifications that serve to clarify and better illustrate the features, according to the invention. In particular, the reaction mixtures 2 that are present in the reaction vessels 1 and the holder for reaction tubes 14 are not shown in FIG. 2A in order to emphasize the arrangement of the temperature control zones 4 and the temperature control elements 9. Furthermore, for illustration clarity reasons, no complete side view of the arrangement in FIG. 2A is shown in FIG. 2B, but instead only its first row of reaction vessels 1 is shown. The fastening of the reaction vessels 1, in particular the shaking flasks, on the agitation platform 10 is not shown either in FIGS. 2A-2B for illustration clarity reasons.

On an agitation platform 10, which is driven by an agitation drive 11, a plurality of reaction mixtures 2 to be individually temperature-controlled are positioned in different reaction vessels 1. The reaction vessels 1 shown include shaking flasks of various sizes as well as culture tubes. The reaction mixtures 2 in their reaction vessels 1 are all exposed to a common agitation 3 on the agitation platform 10. According to the invention, a plurality of temperature control elements 9 are integrated into the agitation platform 10, said temperature control elements each generating separately controllable temperature control zones 4 or being used as insulation zones 5 by being switched off.

FIG. 2A illustrates the combination, according to the invention, of a plurality of temperature control elements 9 or temperature control zones 4 to form combined arrays of small temperature control zones 4 and temperature control elements 9. According to the invention, this combination is performed on the basis of the size of the reaction vessels 1, as shown in FIG. 2A, on the basis of the cross-sections of the reaction vessels 1. Further temperature control elements 9, which are used as isolation zones 5 by being switched off or being used as an active counter-regulation, are found between the combined temperature control zones 4 specific to each reaction vessel. According to the invention, the temperature control elements 9 on the agitation platform 10 can be linked to one another to form temperature control zones 4 or isolation zones 5 to be recombined depending on the loading and positioning of reaction vessels 1 with reaction mixtures 2.

The temperature control zones can be combined by means of a synchronous control of adjacent temperature control elements. If a group of individual temperature control elements is controlled identically, a larger temperature control zone can be formed as a result. An isolation zone can be created by deactivating individual temperature control elements; the gas phase above said zone is then not heated and thus insulates the adjoining temperature control zone.

The reaction vessels 1 with the reaction mixtures 2 contained in them are surrounded by a gaseous phase as the isolation zone 5, which consists of either ambient air or an atmosphere regulated with regard to its composition, pressure, temperature and humidity. In some embodiments of the invention, this gas phase functions simultaneously as an isolation zone 5 and as a weak temperature control zone 4, which performs a heat transfer-limited basic temperature control of all reaction mixtures 2, which is then individually adapted locally by the temperature control elements 9 on the agitation platform 10.

FIG. 2B also shows a holder for reaction tubes 14, which itself in turn has regions with high thermal conductivity as temperature control zones 4 and regions with low thermal conductivity as isolation zones 5. In an advantageous embodiment of the invention, the temperature control elements 9 under the holder for the reaction tubes 14 are adapted to the position of its temperature control zones 4 and isolation zones 5.

The fastening of the shaking flasks as reaction vessels 1 on the agitation platform 10 is not shown in FIGS. 2A-2B for illustration clarity reasons. According to the invention, reaction vessels 1 with the devices customary for them are attached to the agitation platform 10 so that, in an advantageous embodiment of the invention, the heat transfer 6 between the temperature control zone 4 and the reaction mixture 2 is greater than the heat transfer 7 between at least two reaction mixtures 2. In some embodiments of the invention, the fastening device itself can be used as a temperature control zone 4 in order to allow for a suitable heat transfer between at least one temperature control element 9 and the reaction mixture 2 by means of its reaction vessel 1. This applies, for example, to clips and adhesive mats with which shaking flasks are attached to agitation platforms 10. According to the invention, metallic clips or thermally conductive adhesive mats thus function as temperature control zones 4, which allow for a heat transfer between one or more Peltier elements as temperature control element 9 and the reaction mixture 2 through their contact surface with the reaction vessel 1. According to the invention, the same also applies to other devices which are suitable for fastening at least one reaction vessel 1 on the agitation platform 10.

According to the invention, the agitation platform 10 also includes temperature sensors 12 in addition to the temperature control elements 9. In an advantageous embodiment of the invention, the temperature sensors 12 directly detect the temperature of the reaction mixture 2 associated with them, in particular but not exclusively, by means of its emitted infrared radiation. In further embodiments of the invention, the temperature sensors 12 detect the temperature of the reaction vessel 1 associated with them and thus indirectly the temperature of the reaction mixture 2 in the equilibrium. In some configurations of the invention, the temperature sensors also detect the temperature of the temperature control zones 4 or isolation zones 5 or temperature control elements 9.

According to the invention, the temperatures detected by temperature sensors 12 are used to individually regulate the temperature control of individual reaction mixtures 2 in their reaction vessels 1. According to the invention, the detection of temperature gradients between reaction vessels 1, reaction mixtures 2, temperature control zones 4, isolation zones 5 or temperature control elements 9 allows for a particularly precise temperature control. According to the invention, temperature sensors 12 can be attached in a wide variety of planes and positions in order to be able to detect such temperature gradients.

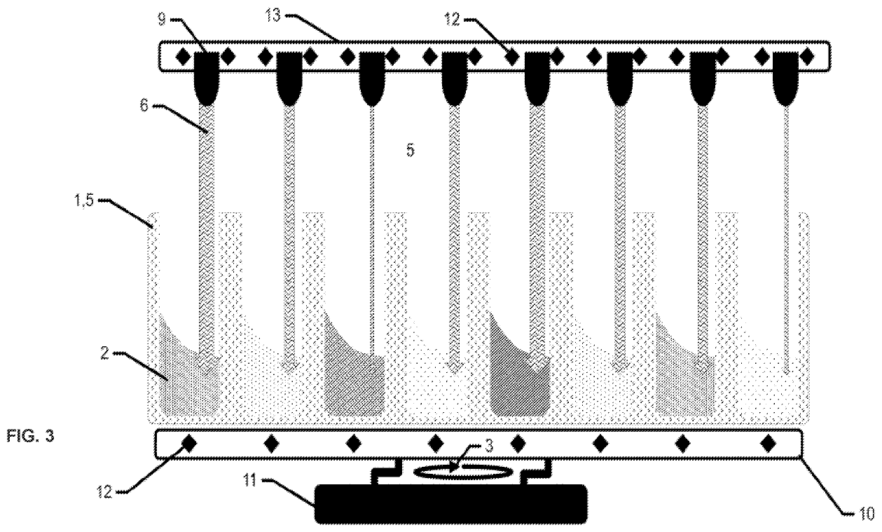

FIG. 3 is a schematic representation of an embodiment of the device, according to the invention, for performing the method, according to the invention, for microtiter plates using infrared lighting for the individual temperature control of each well. According to the invention, a microtiter plate represents an array of interconnected reaction vessels 1 with each well corresponding to a reaction vessel 1 and being filled with a reaction mixture 2 to be individually temperature-controlled. The microtiter plate is attached to a shaken agitation platform 10, which is moved by an agitation drive 11, so that all reaction vessels 1 of the microtiter plate are subjected to a common agitation movement 3.

In order to be able to control the temperature of each well separately, the walls of the microtiter plate and thus the walls of the reaction vessels 1 are designed here as isolation zones 5. The temperature of the individual reaction mixtures 2 is therefore not controlled by means of contact surfaces but rather directly by means of radiation-based heat transfers 6 between the temperature control element 9 and the reaction mixture 2. FIG. 3 is a device, according to the invention, in which infrared radiators (in particular, as IR LEDs) are arranged as temperature control elements 9 in a holder 13 with at least a partial field of view of their associated reaction mixture 2 with at least one infrared radiator individually transferring heat as infrared radiation in an associated reaction mixture 2.

Just as in FIGS. 2A-2B, the reaction vessels 1 with the reaction mixtures 2 contained in them are surrounded by a gaseous phase as the isolation zone 5, which consists of either ambient air or an atmosphere regulated with regard to its composition, pressure, temperature and humidity. In some embodiments of the invention, this gas phase functions simultaneously as an isolation zone 5 and as a weak temperature control zone 4, which performs a heat transfer-limited basic temperature control or cooling of all reaction mixtures 2, which is then individually adapted locally by the infrared radiators as temperature control elements 9.

In some embodiments of the invention, the walls of at least one reaction vessel 1 are partially or completely able to strongly reflect or absorb infrared radiation in order to increase the heat transfer into the reaction mixture 2 either in the mixture itself or on the heated walls of the reaction vessel 1. According to the invention, this is achieved through the selection of suitable reaction vessel materials, colors or coatings.

FIG. 3 shows temperature sensors 12 both in the agitation platform 10 and in an additional holder 13. The temperature sensors 12 in the agitation platform 10 primarily determine the temperature of the reaction vessels 1 whereas the temperature sensors 12 in the holder directly determine the temperature of the reaction mixtures 2 associated with them by means of their IR emission. In an advantageous embodiment of the invention, these IR temperature sensors 12 are either visually clearly separated from the temperature control elements 9 or are modulated and operated in a manner that is matched to the temperature control elements 9. In some embodiments of the invention, these IR temperature sensors 12 are also used to measure and adapt the radiation power of the temperature control elements 9.

In some embodiments of the invention, the holder 13 is also agitated so that there is no relative movement between the reaction vessels 1 and the holder 13. In other embodiments, the holder is fixed externally 13 so that a relative movement occurs between the reaction vessels 1 and the holder 13. In some embodiments of the invention, the association changes the temperature control elements 9 and the temperature sensors 12 to at least one reaction mixture 2 as a result of the relative movement so that, with a suitable control, a plurality of reaction mixtures 2 can be individually temperature-controlled by means of a single combination of a temperature control element 9 and a temperature sensor 12.

### LIST OF REFERENCE NUMBERS

1 Reaction vessel
2 Reaction mixture
3 Agitation movement
4 Temperature control zone
5 Isolation zone
6 Heat transfer between the temperature control zone 4 or the temperature control element 9 and the reaction mixture 2
7 Heat transfer between at least two reaction mixtures 2
8 Heat transfer between at least two temperature control zones 4
9 Temperature control element
10 Agitation platform
11 Agitation drive
12 Temperature sensor
13 Holder
14 Holder for reaction tubes

1-14. (canceled)

15. A method for controlling temperature of reaction mixtures during an agitation operation, the method comprising:
subjecting at least two reaction mixtures in at least two reaction vessels to a common agitation movement; and
individually controlling temperature of the at least two reaction mixtures by means of a separate heat transfer between at least one of the at least two reaction mixtures and at least one temperature control zone associated with the at least one of the at least two reaction mixtures.

16. The method according to claim 15, wherein the temperature is controlled using a plurality of individually controllable temperature control elements.

17. The method according to claim 15, wherein the at least two reaction mixtures or temperature control zones are temperature controlled by individually controlling temperature control elements.

18. The method according to claim 15, wherein the at least two reaction mixtures are separated from one another by at least one isolation zone so that maximum achievable heat transfer between the at least two reaction mixtures is less than maximum achievable heat transfer between one of the at least two temperature control zones and a corresponding reaction mixture.

19. The method according to claim 15, wherein the at least two temperature control zones are separated from one another by at least one isolation zone so that maximum achievable heat transfer between the at least two temperature control zones is less than maximum achievable heat transfer between one of the at reaction mixtures and a corresponding control zone.

20. The method according to claim 15, wherein at least two temperature control zones are combined to form a larger temperature control zone or that at least two temperature control elements are combined to form a larger temperature control element.

21. The method according to claim 15, wherein for a combination of temperature control zones, a first number of temperature control elements are controlled identically while a second number of temperature control elements are controlled differently.

22. The method according to claim 15, wherein a temperature control element locally associated with an isolation zone is switched to inactive in order to form the isolation zone.

23. The method according to claim 22, wherein the combination of the at least two temperature control zones or temperature control elements is associated with positioning or shape of reaction vessels, optionally, by means of a targeted control of the temperature control elements.

24. The method according to claim 15, wherein the at least one temperature control zone or at least one temperature control element is controlled on a basis of measurement information that was recorded by at least one temperature sensor.

25. The method according to claim 15, wherein the at least one temperature control zone or at least one temperature control element is controlled on a basis of measurement data or information that was recorded during a process in, on or in a vicinity of the reaction mixture to be temperature-controlled.

26. A device for carrying out the method according to claim 15, the device comprising:
at least one agitation platform driven by an agitation drive, on which the at least two reaction mixtures are exposed to a common agitation movement in the at least two reaction vessels; and
at least two temperature control elements or temperature control zones which are each associated with one of the at least two reaction mixtures in each of the at least two reaction vessels and by means of which the individual temperature control of at least two reaction mixtures is carried out.

27. The device according to claim 26, further comprising at least one isolation zone which separates the at least two reaction mixtures in such a way that maximum achievable heat transfer between at least two reaction mixtures is smaller than maximum achievable heat transfer between at least one temperature control zone and at least one associated reaction mixture.

28. The device according to claim 27, further comprising a plurality of temperature control zones or temperature control elements which can be freely combined with one another.
